(19) United States
(12) Patent Application Publication
(10) Pub. No.: US 2012/0028581 A1
(43) Pub. Date: Feb. 2, 2012

(54) PORTABLE TERMINAL FOR HAVING DETACHABLE BLUETOOTH HEADSET

(75) Inventors: Byoung-Hee LEE, Seoul (KR); Ki-Won KIM, Suwon-si (KR); Sung-Wook KANG, Seoul (KR); Tae-Kwang RYU, Seoul (KR); Joon-Rae CHO, Seoul (KR)

(73) Assignee: Samsung Electronics Co. Ltd., Suwon-si (KR)

(21) Appl. No.: 13/195,280

(22) Filed: Aug. 1, 2011

(30) Foreign Application Priority Data
Aug. 2, 2010 (KR) 10-2010-0074674

(51) Int. Cl. H04W 88/02; H04B 7/00

(52) U.S. Cl. 455/41.2

(57) ABSTRACT

A portable terminal with a detachable BLUETOOTH headset is provided. The terminal includes the BLUETOOTH headset installed detachably in the portable terminal, a receiver module and a microphone module installed in the BLUETOOTH headset and used for phone call, an electrical connection means for, when the BLUETOOTH headset is installed in the portable terminal, electrically connecting the BLUETOOTH headset with the portable terminal, and a controller for detecting an installation or non-installation of the BLUETOOTH headset and for performing a corresponding operation. When the BLUETOOTH headset is installed in the portable terminal, the receiver module of the BLUETOOTH headset is used as a receiver module for the portable terminal.

### PRIORITY

This application claims priority under 35 U.S.C. §119(a) of a Korean Patent Application filed in the Korean Intellectual Property Office on Aug. 2, 2010 and assigned Serial No. 10-2010-0074674, the entire disclosure of which is hereby incorporated by reference.

### BACKGROUND OF THE INVENTION

1. Field of the Invention

The present invention relates to a portable terminal. More particularly, the present invention relates to a portable terminal for having a detachable BLUETOOTH headset realized to make common use of a receiver module and a microphone module in a case where the BLUETOOTH headset is installed in the portable terminal.

2. Description of the Related Art

Owing in large part to the development of various kinds of electronic and telecommunication industries and technologies, portable terminals are widely popular, and tend to be diversified in function so as to meet users' needs and desires, while also becoming gradually smaller with miniaturization of electronics.

Accordingly, peripheral devices that are attachable or added to the terminals are also in development and use and, for example, may include a built-in digital camera, a smart card that is also an auxiliary memory, an ear microphone mounted on the terminal and installed to enable a phone call, a detachable broadcast antenna for receiving a sky wave broadcast, a BLUETOOTH headset for wirelessly communicating by means of a BLUETOOTH module installed in the terminal, and the like.

The terminals having the BLUETOOTH function mount a separate BLUETOOTH antenna module for operating at a 2.4 GHz band, apart from a main communication antenna module. A predetermined BLUETOOTH antenna module is mounted in a main board of the terminal and performs local area wireless communication with the BLUETOOTH headset.

The BLUETOOTH headset is used as part of a handsfree use of a portable terminal. Since the BLUETOOTH headset does not need a separate cable with the terminal, the BLUETOOTH headset has an advantage not only in that a convenience of terminal manipulation increases, but also in that carrying is simple and convenient in comparison with a general handsfree wired ear microphone. So, adoption of the BLUETOOTH headset has gradually become more generalized.

On the other hand, products improving the portability of the BLUETOOTH headset are recently entering the market. For example, in the case of when the BLUETOOTH headset is not being used, the BLUETOOTH headset is installed in the portable terminal and carried together with the portable terminal, so a danger of forgetting or losing the BLUETOOTH headset is less than when they are carried separately.

But, the above terminal detachable BLUETOOTH headset simply concerns only a carrying convenience, and is difficult to find additional efficiency. For instance, receiver and microphone modules for a portable terminal and receiver and microphone modules for BLUETOOTH should be provided individually, and this has resulted in a problem in that a corresponding cost has been high until now.

### SUMMARY OF THE INVENTION

Aspects of the present invention are to address at least the above-mentioned problems and/or disadvantages and to provide at least the advantages below. Accordingly, an aspect of the present invention is to provide a portable terminal with a detachable BLUETOOTH headset, realized to make common use of a single receiver module and microphone module for both the portable terminal and the BLUETOOTH headset, thus increasing a convenience of use.

Another aspect of the present invention is to provide a portable terminal with a detachable BLUETOOTH headset, realized to make common use of a single receiver module and microphone module for both the portable terminal and the BLUETOOTH headset, thus saving a manufacturing cost.

A further aspect of the present invention is to provide a portable terminal with a detachable BLUETOOTH headset, realized to install a BLUETOOTH headset in a portable terminal and use the BLUETOOTH headset as a constituent element of the portable terminal when the BLUETOOTH headset is not in use, thus minimizing a danger of forgetting or losing the headset and thereby increasing a convenience of use.

Yet another aspect of the present invention is to provide a portable terminal with a detachable BLUETOOTH headset, realized to guarantee a mounting space for a BLUETOOTH headset and simultaneously contribute to a slimming of the terminal.

The above aspects are addressed by providing a portable terminal with a detachable BLUETOOTH headset.

In accordance with an aspect of the present invention, a portable terminal with a detachable BLUETOOTH headset is provided. The terminal includes the BLUETOOTH headset installed detachably in the portable terminal, a receiver module and microphone module installed in the BLUETOOTH headset and used for phone call, an electrical connection means for, when the BLUETOOTH headset is installed in the portable terminal, electrically connecting the BLUETOOTH headset with the portable terminal, and a controller for detecting an installation or non-installation of the BLUETOOTH headset and for performing a corresponding operation. In a case where the BLUETOOTH headset is installed in the portable terminal, the receiver module of the BLUETOOTH headset is used as a receiver module for the portable terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a rear perspective diagram illustrating a portable terminal equipped with a BLUETOOTH headset according to a first exemplary embodiment of the present invention;

FIG. 2 is a rear perspective diagram illustrating a portable terminal unequipped with a BLUETOOTH headset according to the first exemplary embodiment of the present invention;

FIG. 3 is a front perspective diagram illustrating a portable terminal equipped with a BLUETOOTH headset according to the first exemplary embodiment of the present invention;

FIGS. 4A and 4B are perspective diagrams illustrating an operation state of a BLUETOOTH headset according to the first exemplary embodiment of the present invention;

FIG. 5 is a cross-sectional diagram illustrating a key construction of a BLUETOOTH headset according to the first exemplary embodiment of the present invention;

FIG. 6 is a perspective diagram illustrating a construction of a BLUETOOTH headset according to a second exemplary embodiment of the present invention;

FIG. 7 is a perspective diagram illustrating an operation state when a portable terminal is equipped with a BLUETOOTH headset according to the second exemplary embodiment of the present invention;

FIG. 8 is a perspective diagram illustrating a state where a portable terminal is equipped with a BLUETOOTH headset according to the second exemplary embodiment of the present invention;

FIG. 9 is a perspective diagram illustrating a combined state where a portable terminal is equipped with a BLUETOOTH headset according to a third exemplary embodiment of the present invention;

FIG. 10 is a perspective diagram illustrating a combined state where a portable terminal is equipped with a BLUETOOTH headset according to a fourth exemplary embodiment of the present invention; and

FIGS. 11A through 11C are diagrams illustrating a construction of a BLUETOOTH headset according to a fifth exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a”, “an”, and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

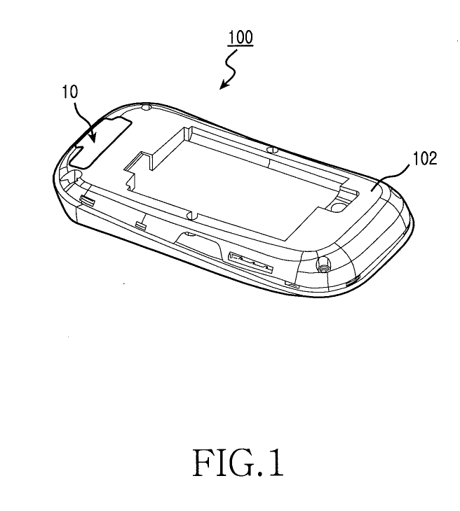

FIGS. 1 through 11C, discussed below, and the various exemplary embodiments used to describe the principles of the present disclosure are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

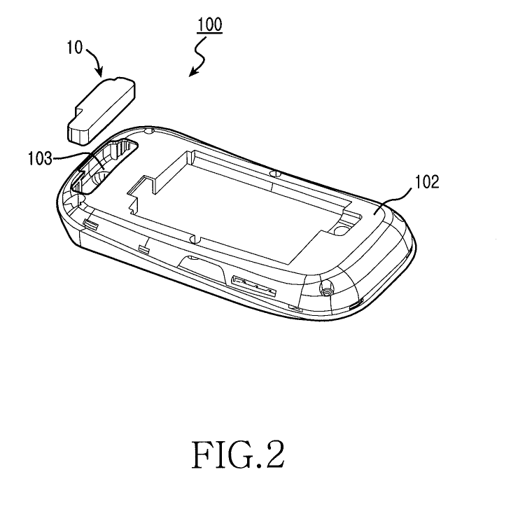

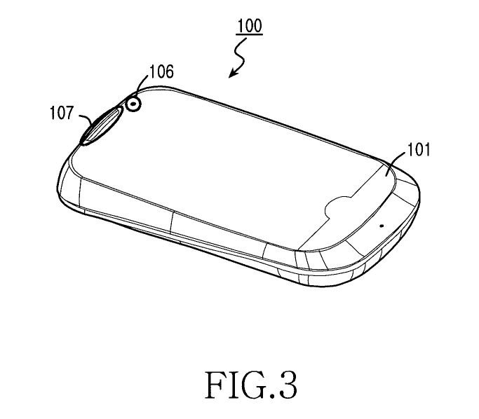

FIG. 1 is a rear perspective diagram illustrating a portable terminal equipped with a BLUETOOTH headset according to a first exemplary embodiment of the present invention. FIG. 2 is a rear perspective diagram illustrating a portable terminal unequipped with a BLUETOOTH headset according to the first exemplary embodiment of the present invention. FIG. 3 is a front perspective diagram illustrating a portable terminal equipped with a BLUETOOTH headset according to the first exemplary embodiment of the present invention.

Referring to FIGS. 1 to 3, a BLUETOOTH headset 10 according to the first exemplary embodiment of the present invention is installed detachably in a suitable place of a portable terminal 100. In the drawings, the portable terminal 100 may have an installation part 103 of a groove shape in a suitable place of the portable terminal's rear surface 102, and the BLUETOOTH headset 10 may be installed detachably in the installation part 103 of the portable terminal 100.

In this exemplary embodiment, the BLUETOOTH headset 10 is installed in the rear surface 102 of the portable terminal 100. In detail, if a battery cover (not shown) detachably installed in the whole rear is uncovered, the installation part 103 may be exposed, and the BLUETOOTH headset 10 may be installed detachably in the exposed installation part 103 of the portable terminal 100.

But, this does not limit the scope of the present invention, and the BLUETOOTH headset 10 may be directly installed detachably in a rear surface 102 of the portable terminal 100 without doing damage to an appearance of the portable terminal 100.

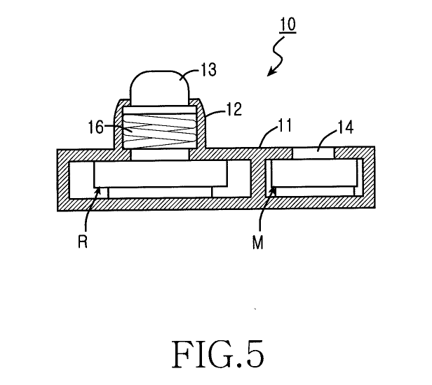

In an exemplary embodiment of the present invention, a receiver module (‘R’ in FIG. 5) and microphone module (‘M’ in FIG. 5) of the BLUETOOTH headset 10 are used as a combined receiver module and microphone module of the portable terminal 100. Thus, in a case where the BLUETOOTH headset 10 is uninstalled from the portable terminal 100 and is used as a handsfree device, the BLUETOOTH headset 10 is used as a general BLUETOOTH headset. But, in a case where the BLUETOOTH headset 10 is installed in the portable terminal 100, the BLUETOOTH headset 10 may not function as the general BLUETOOTH headset but instead function as a receiver module and microphone module of the portable terminal 100. So, desirably, as illustrated in FIG. 3, the BLUETOOTH headset 10 may be installed in a vicinity of a speaker hole 107 and a microphone hole 106 that are formed in a front surface 101 of the portable terminal 100. That is, the receiver module and microphone module of the BLUETOOTH headset 10 may be installed such that they respectively correspond to the speaker hole 107 and the microphone hole 106 of a case frame that is formed in the front surface 101 of the portable terminal 100. More desirably, when the microphone module of the BLUETOOTH headset 10 is used for the portable terminal 100, the microphone module of the BLUETOOTH headset 10 may be used as a sub microphone module that may be used for audio feedback prevention, speaker phone call, and echo cancelation function realization.

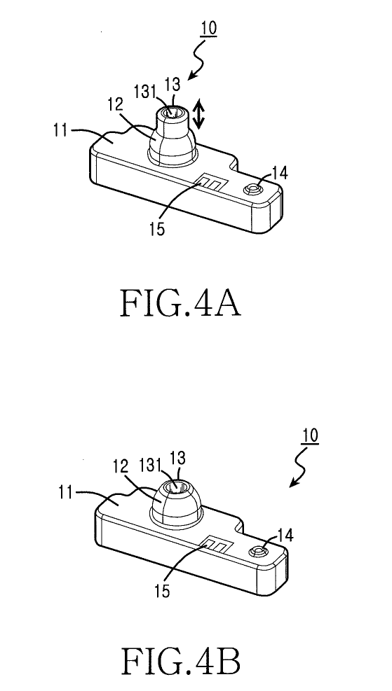

FIGS. 4A and 4B are perspective diagrams illustrating an operation state of a BLUETOOTH headset according to the first exemplary embodiment of the present invention. FIG. 5 is a cross-sectional diagram illustrating a key construction of a BLUETOOTH headset according to the first exemplary embodiment of the present invention.

Referring to FIGS. 4A-4B and 5, the BLUETOOTH headset 10 includes a body 11 shaped to correspond to the installation part 103 of the portable terminal 100, an ear cap 13 having a receiver hole 131 and protrusion-formed in the body 11, and a microphone hole 14 formed at a suitable place of the body 11. The ear cap 13 may be installed to show up from a hollow-type bushing 12 that is protrusion-formed in the body 11. In FIG. 4A the ear cap 13 is shown in an extended state, and in FIG. 4B the ear cap 13 is shown in a retracted state.

Desirably, as illustrated in FIG. 5, when the BLUETOOTH headset 10 is installed in the portable terminal 100, the ear cap 13 may move inside the bushing 12 and, when the BLUETOOTH headset 10 is uninstalled from the portable terminal 100, the ear cap 13 may automatically protrude as much as a predetermined height by means of a predetermined elastic means. The elastic means may be a compression type coil spring 16.

A receiver module (R) may be disposed within the body 11 at a location corresponding to the receiver hole 131 of the ear cap 13, and a microphone module (M) may be disposed within the body 11 at a location corresponding to the microphone hole 14.

A terminal part 15 is constructed in the body 11 of the BLUETOOTH headset 10. When the BLUETOOTH headset 10 is installed in the installation part 103 of the portable terminal 100, the terminal part 15 of the BLUETOOTH headset 10 electrically connects with the portable terminal 100 and allows the receiver module (R) and the microphone module (M) to be used for the portable terminal 100. Thus, although not illustrated, a protruded connector part of an exemplary embodiment of the present invention may be formed in the installation part 103 of the portable terminal 100 to contact the terminal part 15 of the BLUETOOTH headset 10. But, this does not limit the scope of the present invention. For example, if the connector part is formed in the BLUETOOTH headset 10, the terminal part 15 may instead be formed within the installation part 103 of the portable terminal 100.

More desirably, the BLUETOOTH headset 10 uses a general receiver module R used in the portable terminal 100. When the BLUETOOTH headset 10 is used as a BLUETOOTH headset, the receiver module R may reduce an output. More desirably, if a controller of the portable terminal 100 senses through the terminal part 15 that the BLUETOOTH headset 10 is detached from the portable terminal 100, the controller may perform an operation of automatically entering a pairing mode. Also, in a case where the controller of the BLUETOOTH headset 10 senses that the BLUETOOTH headset 10 is detached from the portable terminal 100, the controller may automatically reduce an output of the receiver module R and convert into a BLUETOOTH mode.

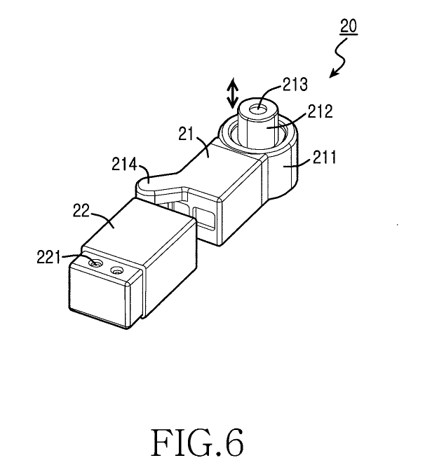

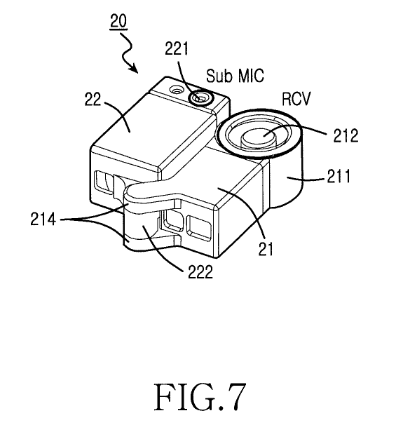

FIG. 6 is a perspective diagram illustrating a construction of a BLUETOOTH headset according to a second exemplary embodiment of the present invention. FIG. 7 is a perspective diagram illustrating an operation state when a portable terminal is equipped with a BLUETOOTH headset according to the second exemplary embodiment of the present invention.

The first exemplary embodiment of the present invention illustrates and describes a bar-type BLUETOOTH headset 10, but this exemplary embodiment illustrates a foldable BLUETOOTH headset 20. The foldable BLUETOOTH headset 20 has an advantage of being capable of efficiently using an installation space of the portable terminal 100. Also, although not illustrated, there is also provided a terminal part similar to terminal part 15 described above for electrically connecting the BLUETOOTH headset 20 with the portable terminal 100 when the BLUETOOTH headset 20 is installed in the portable terminal 100. Other mode conversions upon installation/uninstallation and the like are substantially the same as those of the first exemplary embodiment.

The foldable BLUETOOTH headset 20 includes a first body 21, and a second body 22 installed to rotate with respect to the first body 21. As illustrated in FIG. 7, the first body 21 and the second body 22 may be mutually folded to face each other.

In the first body 21, a bushing 211 may be integrally formed to house an ear cap 212 shown here in an up or extended state, and a receiver hole 213 may be realized in the ear cap 212. In the second body 22, a microphone hole 221 is formed. A receiver module and a microphone module may be disposed in the bodies 21 and 22, respectively. An operation of extending and retracting the ear cap 212 may be realized in the same manner as that of the ear cap 13 of the first exemplary embodiment.

In an exemplary embodiment, a pair of side hinge arms 214 may be formed in the first body 21, and a center hinge arm 222 may be formed in the second body 22 to rotate interposed between the side hinge arms. But, this does not limit the scope of the present invention, and various schemes such as a foldable link, a multiple-joint structure, and the like as well known in the art are applicable.

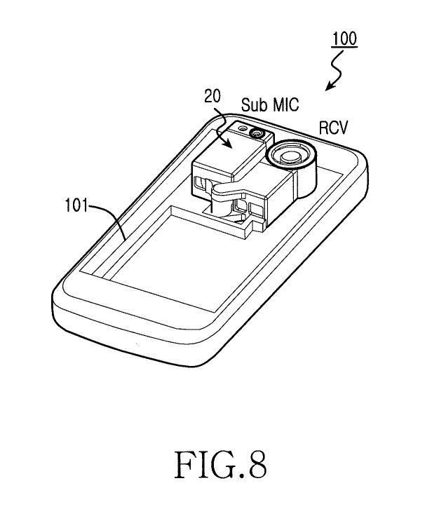

FIG. 8 is a perspective diagram illustrating a state where a portable terminal is equipped with a BLUETOOTH headset according to the second exemplary embodiment of the present invention.

Referring to FIG. 8, in a case where the BLUETOOTH headset 20 is installed and used in a portable terminal 100, in the configuration of FIG. 7, the first body 21 and the second body 22 are folded to be in a more compact shape. In this state, if the BLUETOOTH headset 20 is installed in the portable terminal 100, a receiver module of the BLUETOOTH headset 20 may be used for a receiver module of the portable terminal 100, and a microphone module of the BLUETOOTH headset 20 may be used for a sub microphone module of the portable terminal 100.

In a case where the BLUETOOTH headset 20 is uninstalled from the portable terminal 100 and is used for handsfree use of a privacy call and the like, the first body 21 and the second body 22 may be arranged unfolded and used in a straight line as in FIG. 6.

In the described exemplary embodiments of the present invention, the BLUETOOTH headsets 10 and 20 are described by way of exemplary embodiments of the bar type, the foldable type, and the like, but this does not limit the scope of the present invention. For example, BLUETOOTH headsets of various forms such as a show-up type BLUETOOTH headset in which bodies are shown up in sequence, a type in which a first body itself may be inserted into a user's ear, and the like may be applied according to a mounting space of a portable terminal with which they are to be used. But, all the aforementioned BLUETOOTH headsets make common use of a receiver module and a microphone module for a portable terminal.

In the described exemplary embodiments of the present invention, the BLUETOOTH headset 10 or 20 is installed in the rear surface of the portable terminal 100, but this does not limit the scope of the present invention. Also, various installation schemes may be applied according to a shape of a portable terminal and a shape of a BLUETOOTH headset applied to the portable terminal.

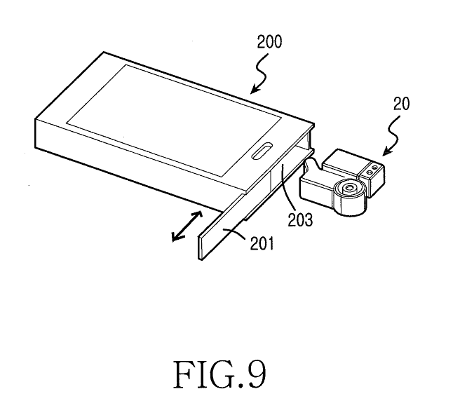

FIG. 9 is a perspective diagram illustrating a combined state where a portable terminal 200 is equipped with a BLUETOOTH headset 20 according to a third exemplary embodiment of the present invention. The portable terminal 200 includes a sliding cover 201 at its top. The cover 201 is installed in a slide scheme. That is, the cover 201 may be opened and closed in an arrow direction of FIG. 9. When the cover 201 is opened, an installation part 203 of the portable terminal 200 may be exposed to install the BLUETOOTH headset 20.

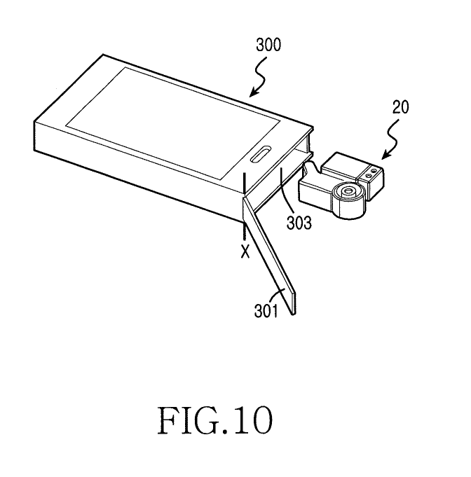

FIG. 10 is a perspective diagram illustrating a combined state where a portable terminal is equipped with a BLUETOOTH headset according to a fourth exemplary embodiment of the present invention. The portable terminal 300 includes a lift-up cover 301 at its top. The cover 301 is opened and closed in a scheme of rotating with respect to axis ‘X’ at one end of the cover 301. After the cover 301 is opened, the installation part 303 of the portable terminal 300 may be exposed to install the BLUETOOTH headset 20.

Referring to FIGS. 9 and 10, in a case where the BLUETOOTH headset 20 is installed in the installation part 203 or 303 of the portable terminal 200 or 300, a receiver module and microphone module of the BLUETOOTH headset 20 may be used for a receiver module and sub microphone module of the portable terminal 200 or 300. That is, two receiver modules or microphone modules used for a portable terminal and a BLUETOOTH headset of the related art may be reduced to a single receiver module or microphone module.

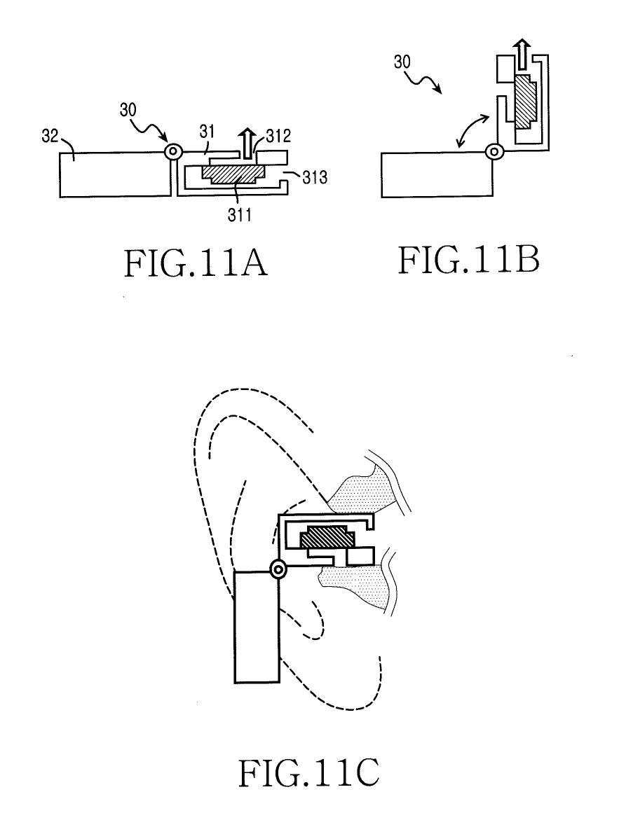

FIGS. 11A through 11C are diagrams illustrating a construction of a BLUETOOTH headset according to a fifth exemplary embodiment of the present invention. The BLUETOOTH headset 30 includes a first body 31 including a speaker module 311, and a second body 32 performing a rotation operation with respect to the first body 31. The first body 31 includes the speaker module 311, and includes two receiver holes 312 and 313. That is, the first body 31 includes the terminal receiver hole 312 used when the BLUETOOTH headset 30 is installed in a portable terminal, and the headset receiver hole 313 used when the BLUETOOTH headset 30 is used as a BLUETOOTH headset. Although not illustrated, a microphone hole including a microphone module may be provided in the second body 32.

Referring to FIG. 11A, when the BLUETOOTH headset 30 is installed in a portable terminal, the BLUETOOTH headset 30 is in a state where the first body 31 and the second body 32 are arranged in accordance with a shape of an installation part of the portable terminal. In this case, voice, sound and the like may be sent through the terminal receiver hole 312. The installation part of the portable terminal may be configured to cover the headset receiving hold 313 when the BLUETOOTH headset 30 is installed in the portable terminal. However, in a case where the BLUETOOTH headset 30 is to be used as a BLUETOOTH headset, the first body 31 and the second body 32 are, for example, used in a state where they are bent to an angle, desirably, an angle of about 90 degrees, as shown in FIG. 11B. In this case, as illustrated in FIG. 11C, in a case where the BLUETOOTH headset 30 is inserted in a user's ear, the terminal receiver hole 312 of the first body 31 is sealed by the outer ear canal of the user's ear. Therefore, a corresponding sound may be sent using the uncovered headset receiver hole 313 formed at a side end of the first body 31.

Accordingly, a portable terminal according to exemplary embodiments of the present invention has an effect of, because common use of a receiver module and microphone module of a detachable BLUETOOTH headset for a portable terminal are enabled, being capable of reducing a number of parts required and saving a manufacturing cost, minimizing a terminal volume dependent on a mounting space of the BLUETOOTH headset, reducing a danger of forgetting or losing the BLUETOOTH headset, and increasing a user's convenience.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A portable terminal with a detachable BLUETOOTH headset, the portable terminal comprising:
the BLUETOOTH headset installed detachably in the portable terminal;
a receiver module and microphone module installed in the BLUETOOTH headset and used for a phone call;
an electrical connection means for, when the BLUETOOTH headset is installed in the portable terminal, electrically connecting the BLUETOOTH headset with the portable terminal; and
a controller for detecting an installation or non-installation of the BLUETOOTH headset and for performing a corresponding operation,
wherein, when the BLUETOOTH headset is installed in the portable terminal, the receiver module of the BLUETOOTH headset is used as a receiver module for the portable terminal.

2. The portable terminal of claim 1, wherein the portable terminal comprises a speaker hole and a sub microphone hole and, when the BLUETOOTH headset is installed in the portable terminal, the receiver module and microphone module of the BLUETOOTH headset are disposed in positions corresponding to the speaker hole and sub microphone hole of the portable terminal.

3. The terminal of claim 2, wherein, when the BLUETOOTH headset is installed in the portable terminal, the microphone module of the BLUETOOTH headset is used as a sub microphone module for the portable terminal.

4. The terminal of claim 1, wherein the BLUETOOTH headset is installed in an installation part of the portable terminal that is formed in a groove formed at a top end part of a rear surface of the portable terminal.

5. The terminal of claim 4, wherein the BLUETOOTH headset is installed in the rear surface under a battery cover of the portable terminal.

6. The terminal of claim 1, wherein the BLUETOOTH headset is installed in an installation part of the portable terminal formed inside the portable terminal under a cover installed to be opened and closed at a top end part of the portable terminal.

7. The terminal of claim 6, wherein the cover performs one of an opening and a closing operation in a slide scheme or a rotating scheme.

8. The terminal of claim 1, wherein the electrical connection means comprises a metallic terminal for electrical contact with an internal terminal of the portable terminal when the BLUETOOTH headset is installed in the portable terminal.

9. The terminal of claim 8, wherein the metallic terminal further comprises a charging terminal for receiving a power source of a battery of the portable terminal and for charging an internal battery of the BLUETOOTH headset.

10. The terminal of claim 1, wherein, if is detected that the BLUETOOTH headset is installed in the portable terminal, the controller connects an audio path of the portable terminal with the receiver module of the BLUETOOTH headset.

11. The terminal of claim 1, wherein, if the controller detects that the BLUETOOTH headset is detached from the portable terminal, the controller automatically enters a pairing mode for BLUETOOTH communication.

12. The terminal of claim 1, wherein the BLUETOOTH headset is constructed in a bar type comprising:
a body; and
an ear cap selectively protrusively installed in the body,
wherein the ear cap is installed in a scheme of being extended by a spring.

13. The terminal of claim 1, wherein the BLUETOOTH headset is constructed in a foldable type comprising:
a first body comprising a receiver module; and
a second body connected to and installed to be rotatable with respect to the first body and comprising a microphone module,
wherein the BLUETOOTH headset is installed in a folded state according to a shape of a receiving part of the portable terminal when the BLUETOOTH headset is installed in the portable terminal.

14. The terminal of claim 13, wherein the first body further comprises an ear cap extended by a spring.

15. The terminal of claim 13, wherein the first body is formed in a shape being capable of insertion inside a user's ear.

16. The terminal of claim 1, wherein, when the electrical connection with the portable terminal is interrupted, the receiver module of the BLUETOOTH headset automatically decreases an output for a BLUETOOTH mode.
